(19) United States
(12) Patent Application Publication
(10) Pub. No.: US 2018/0239876 A1
(43) Pub. Date: Aug. 23, 2018

(54) OPTIMAL CONTRAST INJECTION PROTOCOL ENGINE

(71) Applicant: General Electric Company, Schenectady, NY (US)

(72) Inventors: Federica Zanca, Diegem (BE); Pierre Guntzer, Strasbourg (FR)

(21) Appl. No.: 15/435,657

(22) Filed: Feb. 17, 2017

(51) Int. Cl. G06F 19/00

(52) U.S. Cl. CPC G06F 19/3437

(57) ABSTRACT

Systems, methods and computer program products to provide a patient-specific contrast injection protocol in order to achieve optimal contrast enhancement for a given patient, clinical application, contrast media, CT scanner and protocol, are provided. Aspects of the present disclosure disclosed and described herein enable an optimal contrast product concentration and volume for one or more patients to get the best image quality with the minimum quantity of contrast product in a given computerized tomography (CT) exam.

### CROSS-REFERENCE TO RELATED APPLICATIONS

This patent claims priority to U.S. Provisional Application Ser. No. 62/344,648, entitled “OPTIMAL CONTRAST INJECTION PROTOCOL,” which was filed on Jun. 2, 2016 and is hereby incorporated herein by reference in its entirety.

### FIELD OF DISCLOSURE

The present disclosure relates to providing optimal contrast product concentration and volume for one or more patients to get the best image quality with the minimum quantity of contrast product in a given computerized tomography (CT) exam.

### BACKGROUND

The statements in this section merely provide background information related to the disclosure and may not constitute prior art. The standard clinical practice for cardiac CT angiography is to inject all patients with the same volume of iodinated contrast. Utilization of ionizing contrast product in CT medical X-Ray irradiating exams is a well-known technique used to reduce the X-ray dose delivered to the patient. Contrast products also have negative side effects on patient's health and the minimum quantity of product needed to reach the appropriate quality of image should be used. Nevertheless, protocol used for these kind of exam are often configured with a fixed quantity of product, depending on body region (head, abdomen . . . ) or the class of age of the patient (adult/child). A radiologist is able to estimate the quantity of contrast product needed based on these information, but there is currently no system available to help determine this estimation. Typically, no correction is made due to physical characteristics of individual patients nor are the different scan settings (e.g. kVp) and contrast product details (e.g. iodine concentration) taken into account. This results in highly fluctuating objective image quality (HU density) and high iodine doses for small patients, with possibly added renal burden.

### BRIEF SUMMARY

In view of the above, there is a need for systems, methods, and computer program products which can be used by the radiologist or technologist, whose purpose is to provide a patient-specific injection contrast protocol in order to achieve a desirable and uniform (intra- and inter-patient) organ-specific contrast enhancement for a given patient, clinical application, contrast media, CT scanner and protocol. The above-mentioned needs are addressed by the subject matter described herein and will be understood in the following specification.

According to one aspect of the present disclosure, a system that allows a patient-specific injection contrast protocol in order to achieve a desirable and uniform (intra- and inter-patient) organ-specific contrast enhancement for a given patient, clinical application, contrast media, CT scanner and protocol is provided.

According to another aspect of the present disclosure, a method that allows a patient-specific contrast injection protocol in order to achieve a desirable and uniform (intra- and inter-patient) organ-specific contrast enhancement for a given patient, clinical application, contrast media, CT scanner and protocol is provided.

This summary briefly describes aspects of the subject matter described below in the Detailed Description, and is not intended to be used to limit the scope of the subject matter described in the present disclosure.

### BRIEF DESCRIPTION OF THE DRAWINGS

The features and technical aspects of the system and method disclosed herein will become apparent in the following Detailed Description set forth below when taken in conjunction with the drawings in which like reference numerals indicate identical or functionally similar elements.

FIG. 1 shows a block diagram of an example healthcare-focused information system.

FIG. 2 shows a block diagram of an example healthcare information infrastructure including one or more systems.

FIG. 3 is a block diagram illustrating an example optimal contrast injection protocol system, according to the present disclosure.

FIG. 4 shows a flow diagram illustrating an example method of operating the system of FIG. 3 for creating an optimal patient-specific contrast injection protocol, according to the present disclosure.

FIG. 5 shows a flow diagram illustrating an example method of operating the system of FIG. 3 for optimal patient-specific contrast injection protocol, according to the present disclosure.

FIG. 6 shows a block diagram of an example processor system that can be used to implement systems and methods described herein.

### DETAILED DESCRIPTION

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and other changes may be made without departing from the scope of the subject matter of this disclosure. The following detailed description is, therefore, provided to describe an exemplary implementation and not to be taken as limiting on the scope of the subject matter described in this disclosure. Certain features from different aspects of the following description may be combined to form yet new aspects of the subject matter discussed below.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

### I. Overview

Aspects disclosed and described herein enable providing for a patient-specific contrast protocol in order to achieve a desirable and uniform (intra- and inter-patient) organ-specific contrast enhancement for a given patient, clinical application, contrast media, CT scanner and protocol. The system will help in reducing the high variability of Hounsfield Units (HU), which represent the attenuation of x-rays, for the same clinical indication and therefore in getting a more homogeneous image quality (IQ) across and within patients for a consistent interpretability of contrast images. Currently, HU threshold per clinical indication are difficult to establish because of the large variability due to non-standard protocols. Traditionally, all patients receive a fixed iodine dose regardless of their habitus (physical state) or the specific scan protocol used, e.g., 80 kVp, 100 kVP, etc.). Image quality, in particular, the HU enhancement, the iodine dose should be modified to both patient habitus and kVp; however, iodine is known to have high toxicity and can adversely affect renal function.

Given the above, the present application provides a way to define thresholds per clinical indication and which in some aspects may help manage risk of contrast-induced nephropathy as contrast volume can potentially be reduced for the patient. In addition, the present application may be used for additional clinical purposes such as input for a clinical decision support tool, for example.

In certain aspects, the present application uses data such as input: 1) anatomical region/target organs. These may include but are not limited to the head, thorax, abdomen, liver, lower limbs, etc.; 2) Clinical indication, which defines the image quality. For example, for a good cardiac CTA one could say that 400 HU enhancement in the aorta is aimed for each patient independent of exposure settings, patient habitus (physical characteristics or other physiological parameters, e.g., heart beat or contrast concentration. In certain aspects, the present application may help to define a common HU baseline (harmonization); 3) Patient-related factors: Body habitus parameters, such as weight, height, body mass index, body surface area, lean body mass, fat free body mass, fat percent in the body, SSDE, SSDE WED, attenuation, contour; timing parameters: cardiac output, heartbeat, venous access, etc.; Clinical information: disease state, renal function, risk factors such as Creatinine level, EGFR level, diabetes, cardiopathy, allergy to contrast media, hypertension, hepatic disease, etc.; or 4) Other factors such as gender, age and ethnicity, for example; 5) CT-related scanning factors, e.g., trigger level, scan delay, kVp, scan duration, device type, ECG-gating, radiation, multi-phase scan, scan direction, etc.; 6) Contrast media-related factors such as: product type, concentration, volume saline flush, rate injection duration, viscosity, physiochemistry, injection pattern etc. Note, these parameters may come from a variety of source such as: the scan protocol, device protocol, ECG device, Hospital Information System (HIS), topogram (DICOM image acquired before the exam), for example. In certain aspects, only a subset of the inputs listed above are relevant and used.

Other aspects, such as those discussed in the following and others as can be appreciated by one having ordinary skill in the art upon reading the enclosed description, are also possible.

### II. Example Operating Environment

Health information, also referred to as healthcare information and/or healthcare data, relates to information generated and/or used by a healthcare entity. Health information can be information associated with health of one or more patients, for example. Health information may include protected health information (PHI), as outlined in the Health Insurance Portability and Accountability Act (HIPAA), which is identifiable as associated with a particular patient and is protected from unauthorized disclosure. Health information can be organized as internal information and external information. Internal information includes patient encounter information (e.g., patient-specific data, aggregate data, comparative data, etc.) and general healthcare operations information, etc. External information includes comparative data, expert and/or knowledge-based data, etc. Information can have both a clinical (e.g., diagnosis, treatment, prevention, etc.) and administrative (e.g., scheduling, billing, management, etc.) purpose.

Institutions, such as healthcare institutions, having complex network support environments and sometimes chaotically driven process flows utilize secure handling and safeguarding of the flow of sensitive information (e.g., personal privacy). A need for secure handling and safeguarding of information increases as a demand for flexibility, volume, and speed of exchange of such information grows. For example, healthcare institutions provide enhanced control and safeguarding of the exchange and storage of sensitive patient PHI and employee information between diverse locations to improve hospital operational efficiency in an operational environment typically having a chaotic-driven demand by patients for hospital services. In certain examples, patient identifying information can be masked or even stripped from certain data depending upon where the data is stored and who has access to that data. In some examples, PHI that has been “de-identified” can be re-identified based on a key and/or other encoder/decoder.

A healthcare information technology infrastructure can be adapted to service multiple business interests while providing clinical information and services. Such an infrastructure may include a centralized capability including, for example, a data repository, reporting, discreet data exchange/connectivity, “smart” algorithms, personalization/consumer decision support, etc. This centralized capability provides information and functionality to a plurality of users including medical devices, electronic records, access portals, pay for performance (P4P), chronic disease models, and clinical health information exchange/regional health information organization (HIE/RHIO), and/or enterprise pharmaceutical studies, home health, for example.

Interconnection of multiple data sources helps enable an engagement of all relevant members of a patient's care team and helps improve an administrative and management burden on the patient for managing his or her care. Particularly, interconnecting the patient's electronic medical record and/or other medical data can help improve patient care and management of patient information. Furthermore, patient care compliance is facilitated by providing tools that automatically adapt to the specific and changing health conditions of the patient and provide comprehensive education and compliance tools to drive positive health outcomes.

In certain examples, healthcare information can be distributed among multiple applications using a variety of database and storage technologies and data formats. To provide a common interface and access to data residing across these applications, a connectivity framework (CF) can be provided which leverages common data and service models (CDM and CSM) and service oriented technologies, such as an enterprise service bus (ESB) to provide access to the data.

In certain examples, a variety of user interface frameworks and technologies can be used to build applications for health information systems including, but not limited to, MICROSOFT® ASP.NET, AJAX®, MICROSOFT® Windows Presentation Foundation, GOOGLE® Web Toolkit, MICROSOFT® Silverlight, ADOBE®, and others. Applications can be composed from libraries of information widgets to display multi-content and multi-media information, for example. In addition, the framework enables users to tailor layout of applications and interact with underlying data.

In certain examples, an advanced Service-Oriented Architecture (SOA) with a modern technology stack helps provide robust interoperability, reliability, and performance. Example SOA includes a three-fold interoperability strategy including a central repository (e.g., a central repository built from Health Level Seven (HL7) transactions), services for working in federated environments, and visual integration with third-party applications. Certain examples provide portable content enabling plug 'n play content exchange among healthcare organizations. A standardized vocabulary using common standards (e.g., LOINC, SNOMED CT, RxNorm, FDB, ICD-9, ICD-10, etc.) is used for interoperability, for example. Certain examples provide an intuitive user interface to help minimize end-user training. Certain examples facilitate user-initiated launching of third-party applications directly from a desktop interface to help provide a seamless workflow by sharing user, patient, and/or other contexts. Certain examples provide real-time (or at least substantially real time assuming some system delay) patient data from one or more information technology (IT) systems and facilitate comparison(s) against evidence-based best practices. Certain examples provide one or more dashboards for specific sets of patients. Dashboard(s) can be based on condition, role, and/or other criteria to indicate variation(s) from a desired practice, for example.

A. Example Healthcare Information System

An information system can be defined as an arrangement of information/data, processes, and information technology that interact to collect, process, store, and provide informational output to support delivery of healthcare to one or more patients. Information technology includes computer technology (e.g., hardware and software) along with data and telecommunications technology (e.g., data, image, and/or voice network, etc.).

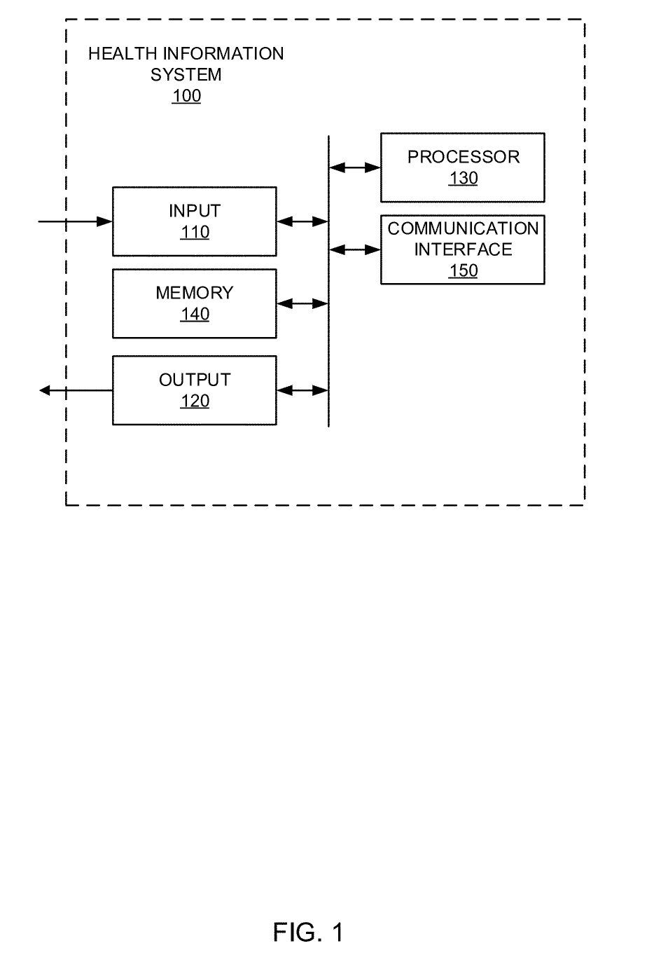

Turning now to the figures, FIG. 1 shows a block diagram of an example healthcare-focused information system 100. Example system 100 can be configured to implement a variety of systems and processes including image storage (e.g., picture archiving and communication system (PACS), etc.), image processing and/or analysis, radiology reporting and/or review (e.g., radiology information system (RIS), etc.), computerized provider order entry (CPOE) system, clinical decision support, patient monitoring, population health management (e.g., population health management system (PHMS), health information exchange (HIE), etc.), healthcare data analytics, cloud-based image sharing, electronic medical record (e.g., electronic medical record system (EMR), electronic health record system (EHR), electronic patient record (EPR), personal health record system (PHR), etc.), and/or other health information system (e.g., clinical information system (CIS), hospital information system (HIS), patient data management system (PDMS), laboratory information system (LIS), cardiovascular information system (CVIS), etc.

As illustrated in FIG. 1, the example information system 100 includes an input 110, an output 120, a processor 130, a memory 140, and a communication interface 150. The components of example system 100 can be integrated in one device or distributed over two or more devices.

Example input 110 may include a keyboard, a touch-screen, a mouse, a trackball, a track pad, optical barcode recognition, voice command, etc. or combination thereof used to communicate an instruction or data to system 100. Example input 110 may include an interface between systems, between user(s) and system 100, etc.

Example output 120 can provide a display generated by processor 130 for visual illustration on a monitor or the like. The display can be in the form of a network interface or graphic user interface (GUI) to exchange data, instructions, or illustrations on a computing device via communication interface 150, for example. Example output 120 may include a monitor (e.g., liquid crystal display (LCD), plasma display, cathode ray tube (CRT), etc.), light emitting diodes (LEDs), a touch-screen, a printer, a speaker, or other conventional display device or combination thereof.

Example processor 130 includes hardware and/or software configuring the hardware to execute one or more tasks and/or implement a particular system configuration. Example processor 130 processes data received at input 110 and generates a result that can be provided to one or more of output 120, memory 140, and communication interface 150. For example, example processor 130 can take user annotation provided via input 110 with respect to an image displayed via output 120 and can generate a report associated with the image based on the annotation. As another example, processor 130 can process updated patient information obtained via input 110 to provide an updated patient record to an EMR via communication interface 150.

Example memory 140 may include a relational database, an object-oriented database, a data dictionary, a clinical data repository, a data warehouse, a data mart, a vendor neutral archive, an enterprise archive, etc. Example memory 140 stores images, patient data, best practices, clinical knowledge, analytics, reports, etc. Example memory 140 can store data and/or instructions for access by the processor 130. In certain examples, memory 140 can be accessible by an external system via the communication interface 150.

In certain examples, memory 140 stores and controls access to encrypted information, such as patient records, encrypted update-transactions for patient medical records, including usage history, etc. In an example, medical records can be stored without using logic structures specific to medical records. In such a manner, memory 140 is not searchable. For example, a patient's data can be encrypted with a unique patient-owned key at the source of the data. The data is then uploaded to memory 140. Memory 140 does not process or store unencrypted data thus minimizing privacy concerns. The patient's data can be downloaded and decrypted locally with the encryption key.

For example, memory 140 can be structured according to provider, patient, patient/provider association, and document. Provider information may include, for example, an identifier, a name, and address, a public key, and one or more security categories. Patient information may include, for example, an identifier, a password hash, and an encrypted email address. Patient/provider association information may include a provider identifier, a patient identifier, an encrypted key, and one or more override security categories. Document information may include an identifier, a patient identifier, a clinic identifier, a security category, and encrypted data, for example.

Example communication interface 150 facilitates transmission of electronic data within and/or among one or more systems. Communication via communication interface 150 can be implemented using one or more protocols. In some examples, communication via communication interface 150 occurs according to one or more standards (e.g., Digital Imaging and Communications in Medicine (DICOM), Health Level Seven (HL7), ANSI X12N, etc.). Example communication interface 150 can be a wired interface (e.g., a data bus, a Universal Serial Bus (USB) connection, etc.) and/or a wireless interface (e.g., radio frequency, infrared, near field communication (NFC), etc.). For example, communication interface 150 may communicate via wired local area network (LAN), wireless LAN, wide area network (WAN), etc. using any past, present, or future communication protocol (e.g., BLUETOOTH™, USB 2.0, USB 3.0, etc.).

In certain examples, a Web-based portal may be used to facilitate access to information, patient care and/or practice management, etc. Information and/or functionality available via the Web-based portal may include one or more of order entry, laboratory test results review system, patient information, clinical decision support, medication management, scheduling, electronic mail and/or messaging, medical resources, etc. In certain examples, a browser-based interface can serve as a zero footprint, zero download, and/or other universal viewer for a client device.

In certain examples, the Web-based portal serves as a central interface to access information and applications, for example. Data may be viewed through the Web-based portal or viewer, for example. Additionally, data may be manipulated and propagated using the Web-based portal, for example. Data may be generated, modified, stored and/or used and then communicated to another application or system to be modified, stored and/or used, for example, via the Web-based portal, for example.

The Web-based portal may be accessible locally (e.g., in an office) and/or remotely (e.g., via the Internet and/or other private network or connection), for example. The Web-based portal may be configured to help or guide a user in accessing data and/or functions to facilitate patient care and practice management, for example. In certain examples, the Web-based portal may be configured according to certain rules, preferences and/or functions, for example. For example, a user may customize the Web portal according to particular desires, preferences and/or requirements.

B. Example Healthcare Infrastructure

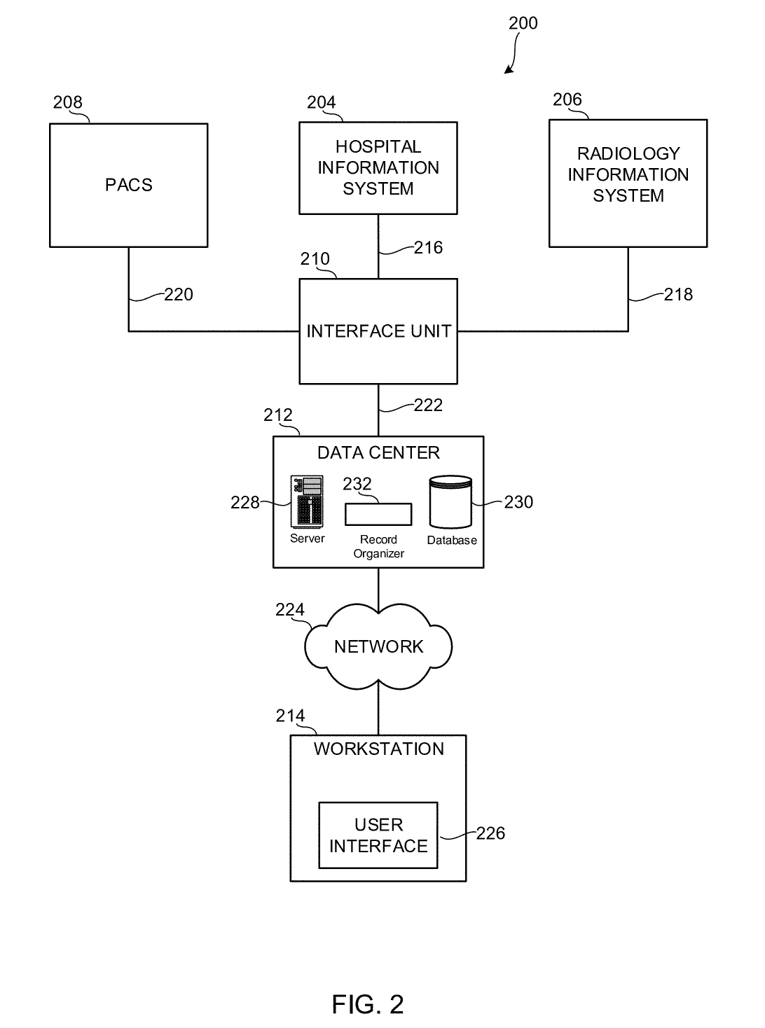

FIG. 2 shows a block diagram of an example healthcare information infrastructure 200 including one or more subsystems such as the example healthcare-related information system 100 illustrated in FIG. 1. Example healthcare system 200 includes a HIS 204, a RIS 206, a PACS 208, an interface unit 210, a data center 212, and a workstation 214. In the illustrated example, HIS 204, RIS 206, and PACS 208 are housed in a healthcare facility and locally archived. However, in other implementations, HIS 204, RIS 206, and/or PACS 208 may be housed within one or more other suitable locations. In certain implementations, one or more of PACS 208, RIS 206, HIS 204, etc., may be implemented remotely via a thin client and/or downloadable software solution. Furthermore, one or more components of the healthcare system 200 can be combined and/or implemented together. For example, RIS 206 and/or PACS 208 can be integrated with HIS 204; PACS 208 can be integrated with RIS 206; and/or the three example information systems 204, 206, and/or 208 can be integrated together. In other example implementations, healthcare system 200 includes a subset of the illustrated information systems 204, 206, and/or 208. For example, healthcare system 200 may include only one or two of HIS 204, RIS 206, and/or PACS 208. Information (e.g., scheduling, test results, exam image data, observations, diagnosis, etc.) can be entered into HIS 204, RIS 206, and/or PACS 208 by healthcare practitioners (e.g., radiologists, physicians, and/or technicians) and/or administrators before and/or after patient examination.

The HIS 204 stores medical information such as clinical reports, patient information, and/or administrative information received from, for example, personnel at a hospital, clinic, and/or a physician's office (e.g., an EMR, EHR, PHR, etc.). RIS 206 stores information such as, for example, radiology reports, radiology exam image data, messages, warnings, alerts, patient scheduling information, patient demographic data, patient tracking information, and/or physician and patient status monitors. Additionally, RIS 206 enables exam order entry (e.g., ordering an x-ray of a patient) and image and film tracking (e.g., tracking identities of one or more people that have checked out a film). In some examples, information in RIS 206 is formatted according to the HL-7 (Health Level Seven) clinical communication protocol. In certain examples, a medical exam distributor is located in RIS 206 to facilitate distribution of radiology exams to a radiologist workload for review and management of the exam distribution by, for example, an administrator.

PACS 208 stores medical images (e.g., x-rays, scans, three-dimensional renderings, etc.) as, for example, digital images in a database or registry. In some examples, the medical images are stored in PACS 208 using the Digital Imaging and Communications in Medicine (DICOM) format. Images are stored in PACS 208 by healthcare practitioners (e.g., imaging technicians, physicians, radiologists) after a medical imaging of a patient and/or are automatically transmitted from medical imaging devices to PACS 208 for storage. In some examples, PACS 208 can also include a display device and/or viewing workstation to enable a healthcare practitioner or provider to communicate with PACS 208.

The interface unit 210 includes a hospital information system interface connection 216, a radiology information system interface connection 218, a PACS interface connection 220, and a data center interface connection 222. Interface unit 210 facilities communication among HIS 204, RIS 206, PACS 208, and/or data center 212. Interface connections 216, 218, 220, and 222 can be implemented by, for example, a Wide Area Network (WAN) such as a private network or the Internet. Accordingly, interface unit 210 includes one or more communication components such as, for example, an Ethernet device, an asynchronous transfer mode (ATM) device, an 802.11 device, a DSL modem, a cable modem, a cellular modem, etc. In turn, the data center 212 communicates with workstation 214, via a network 224, implemented at a plurality of locations (e.g., a hospital, clinic, doctor's office, other medical office, or terminal, etc.). Network 224 is implemented by, for example, the Internet, an intranet, a private network, a wired or wireless Local Area Network, and/or a wired or wireless Wide Area Network. In some examples, interface unit 210 also includes a broker (e.g., a Mitra Imaging's PACS Broker) to allow medical information and medical images to be transmitted together and stored together.

Interface unit 210 receives images, medical reports, administrative information, exam workload distribution information, and/or other clinical information from the information systems 204, 206, 208 via the interface connections 216, 218, 220. If necessary (e.g., when different formats of the received information are incompatible), interface unit 210 translates or reformats (e.g., into Structured Query Language (“SQL”) or standard text) the medical information, such as medical reports, to be properly stored at data center 212. The reformatted medical information can be transmitted using a transmission protocol to enable different medical information to share common identification elements, such as a patient name or social security number. Next, interface unit 210 transmits the medical information to data center 212 via data center interface connection 222. Finally, medical information is stored in data center 212 in, for example, the DICOM format, which enables medical images and corresponding medical information to be transmitted and stored together.

The medical information is later viewable and easily retrievable at workstation 214 (e.g., by their common identification element, such as a patient name or record number). Workstation 214 can be any equipment (e.g., a personal computer) capable of executing software that permits electronic data (e.g., medical reports) and/or electronic medical images (e.g., x-rays, ultrasounds, MRI scans, etc.) to be acquired, stored, or transmitted for viewing and operation. Workstation 214 receives commands and/or other input from a user via, for example, a keyboard, mouse, track ball, microphone, etc. Workstation 214 is capable of implementing a user interface 226 to enable a healthcare practitioner and/or administrator to interact with healthcare system 200. For example, in response to a request from a physician, user interface 226 presents a patient medical history. In other examples, a radiologist is able to retrieve and manage a workload of exams distributed for review to the radiologist via user interface 226. In further examples, an administrator reviews radiologist workloads, exam allocation, and/or operational statistics associated with the distribution of exams via user interface 226. In some examples, the administrator adjusts one or more settings or outcomes via user interface 226.

Example data center 212 of FIG. 2 is an archive to store information such as images, data, medical reports, and/or, more generally, patient medical records. In addition, data center 212 can also serve as a central conduit to information located at other sources such as, for example, local archives, hospital information systems/radiology information systems (e.g., HIS 204 and/or RIS 206), or medical imaging/storage systems (e.g., PACS 208 and/or connected imaging modalities). That is, the data center 212 can store links or indicators (e.g., identification numbers, patient names, or record numbers) to information. In the illustrated example, data center 212 is managed by an application server provider (ASP) and is located in a centralized location that can be accessed by a plurality of systems and facilities (e.g., hospitals, clinics, doctor's offices, other medical offices, and/or terminals). In some examples, data center 212 can be spatially distant from HIS 204, RIS 206, and/or PACS 208.

Example data center 212 of FIG. 2 includes a server 228, a database 230, and a record organizer 232. Server 228 receives, processes, and conveys information to and from the components of healthcare system 200. Database 230 stores the medical information described herein and provides access thereto. Example record organizer 232 of FIG. 2 manages patient medical histories, for example. Record organizer 232 can also assist in procedure scheduling, for example.

Certain examples can be implemented as cloud-based clinical information systems and associated methods of use. An example cloud-based clinical information system enables healthcare entities (e.g., patients, clinicians, sites, groups, communities, and/or other entities) to share information via web-based applications, cloud storage and cloud services. For example, the cloud-based clinical information system may enable a first clinician to securely upload information into the cloud-based clinical information system to allow a second clinician to view and/or download the information via a web application. Thus, for example, the first clinician may upload an x-ray image into the cloud-based clinical information system, and the second clinician may view the x-ray image via a web browser and/or download the x-ray image onto a local information system employed by the second clinician.

In certain examples, users (e.g., a patient and/or care provider) can access functionality provided by system 200 via a software-as-a-service (SaaS) implementation over a cloud or other computer network, for example. In certain examples, all or part of system 200 can also be provided via platform as a service (PaaS), infrastructure as a service (IaaS), etc. For example, system 200 can be implemented as a cloud-delivered Mobile Computing Integration Platform as a Service. A set of consumer-facing Web-based, mobile, and/or other applications enable users to interact with the PaaS, for example.

C. Example Methods of Use

Parameters Influencing HU Enhancement

There are many parameters the affect HU enhancement and are important for optimizing contract injection. These parameters have different effects on image quality and their interactions are complex requiring the present system to evaluate and control. In certain aspects, the present system uses a combination, either some or all of the parameters discussed below to optimize contrast product concentration and volume for one or more patients to get the best image quality with the minimum quantity of contrast product in a given computerized tomography (CT) exam.

kVp: Certain examples determine the effect of kVp on HU enhancement and use this information to determine scaling factors that may be applied in combination with other variables as discussed below.

Total Body Weight: Total body weight has a strongly inversely proportional influence on contrast enhancement and this effect has a non-linear component.

Height: Contrast is administered and is gradually being diluted in the blood stream. Therefore, height is correlated with dilution and may be taken into account.

Gender: Gender is important since, men are not only taller on average, but their artery size is larger as well, thus more mixing of the blood and contrast material is expected and also must be taken into account.

Body Mass Index (BMI): BMI is an indication of body size, however, while it can be a good scaling factor for contrast, it cannot distinguish muscle from fat tissue which could affect image quality.

Body Surface Area (BSA): BSA is traditionally used to correct for patient size when administering a drug. It is also used as a guide in iodine contrast administration.

Lean Body Mass (LBM): LBM is the total weight of the person minus the fat tissue. It may be used to help determine proper iodine administration.

Fat-Free Mass (FFM): FFM is similar to LBM. While LBM still has some small essential fat, such as fat in the organs and central nervous system, FFM subtracts all body fat. It may be used to help determine proper iodine administration.

In certain aspects, these items can be considered either alone or in combination or combinations, for most CT examinations. In certain aspects, the body size descriptors mentioned above are used to determine proper HU enhancement by analyzing their contribution to overall HU enhancement by calculating their effect as a function iodine concentration or other additional factors.

In certain aspects, a patient-specific injection protocol can be determined by selecting a combination of body parameters and calculating the optimal injection protocol from the method derived.

III. Example System

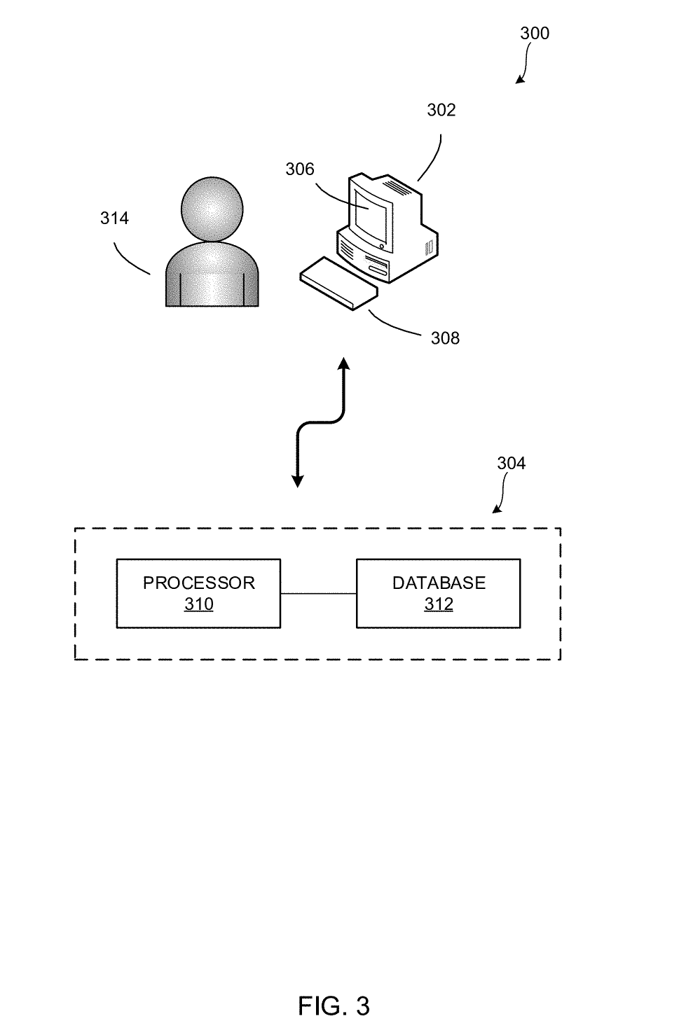

FIG. 3 depicts an example system 300 for optimizing contrast injection according to one aspect of the present disclosure. System 300 includes a computer 302 and an optimal contrast injection protocol engine 304 communicatively coupled to computer 302. In this example, computer 302 includes a user interface 306 and a data input (e.g., a keyboard, mouse, microphone, etc.) 308 and optimal contrast injection protocol engine 304 includes a processor 310 and a database 312.

In certain aspects, user interface 306 displays data such as data and images received from optimal contrast injection protocol engine 304. In certain aspects, user interface 306 receives commands and/or input from a user 314 via data input 308. In certain aspects where system 300 is used to provide an optimal contrast injection protocol, user interface 306 displays protocol parameters and other healthcare-related data.

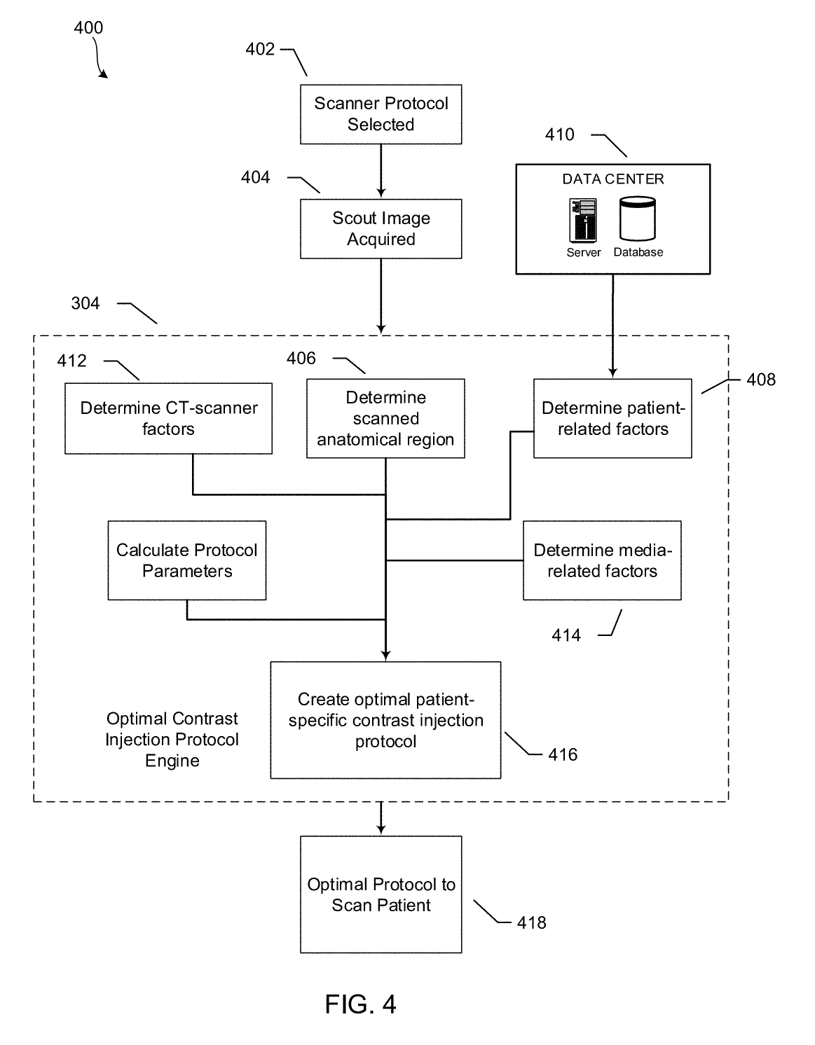

FIG. 4 illustrates a flow diagram of optimal contrast injection protocol engine 304 according to one aspect of the present disclosure. In certain aspects, a specific scanner protocol 402 is selected on a CT machine that will image the patient depending on clinical indication. CT machine acquires a scout image 404 prior to the exam. Data from scout image 404 are sent to optimal contrast injection protocol engine 304. Optimal contrast injection protocol engine 304 1) determines the scanned anatomical region 406, which in certain aspects includes organ recognition. In certain examples, determining the anatomical region could be done by the scanner; 2) determines patient-related factors 408 that affects the scanning protocol from data from data center 410 which contains patient information; 3) determines CT-scanner factors 412 which are scanner specific; 4) determines media-related factors 414 which are related to the contrast being used. Using these values optimal contrast injection protocol engine 304 creates an optimal patient-specific contrast injection protocol 416. In certain aspects, patient-specific contrast product protocol provides information concerning optimal volume, concentration, saline flush, injection rate, injection duration, injection pattern, etc. Optimal Protocol 418 is then used to scan the patient.

IV. Example Method

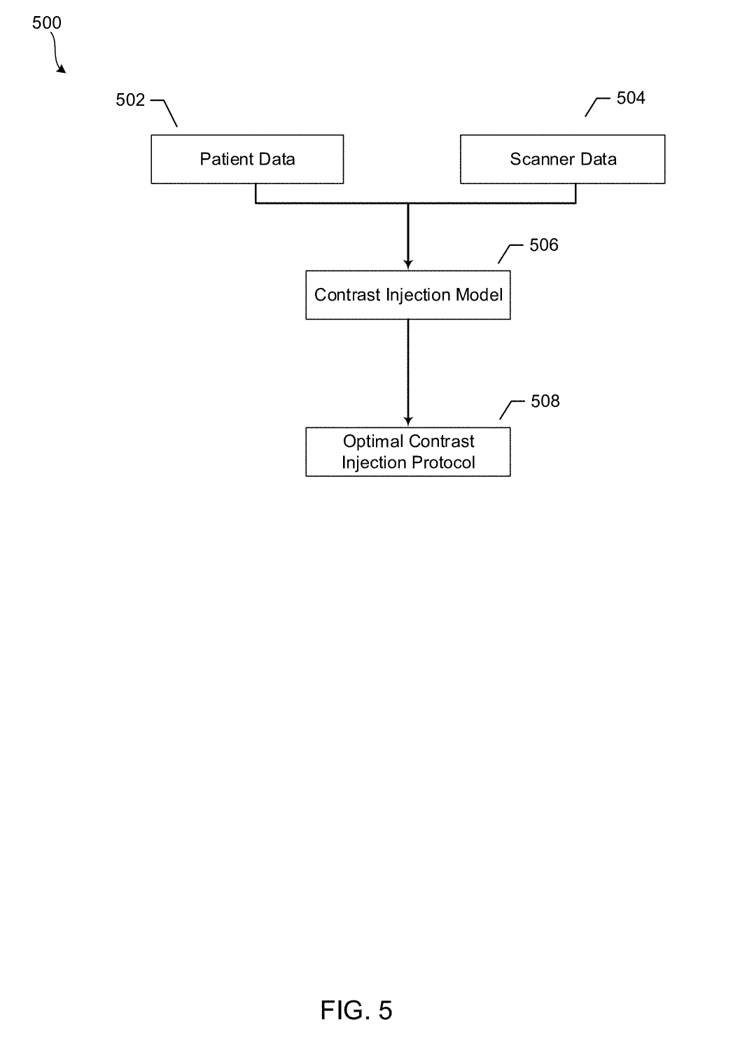

Referring now to FIG. 5, in certain examples, data is retrospectively collected from a patient undergoing the exam and an optimal correlation between HU enhancement and body habitus is calculated. In certain aspects, body habitus normalized to total iodine dose (TID) is determined by considering one or more of the following parameters: weight, BMI, BSA, LBM, and FFM, etc. Using a combination of patient data 502 and scanner data 504, contrast injection model 508 computes the optimal contrast concentration to achieve a desired target enhancement value. In order to adapt the protocol to other kVp settings, in certain aspects, scaling factors can be applied to the TID. In certain aspects, body factors described above are used alone or in combination with gender, kV of the exposure, TID rescaling and correct amount of mgl to be injected is calculated by contrast injection model 506.

As mentioned above, the example processes of FIGS. 4 and 5 can be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIG. 5 can be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

V. Computing Device

The subject matter of this description may be implemented as stand-alone system or for execution as an application capable of execution by one or more computing devices. The application (e.g., webpage, downloadable applet or other mobile executable) can generate the various displays or graphic/visual representations described herein as graphic user interfaces (GUIs) or other visual illustrations, which may be generated as webpages or the like, in a manner to facilitate interfacing (receiving input/instructions, generating graphic illustrations) with users via the computing device(s).

Memory and processor as referred to herein can be stand-alone or integrally constructed as part of various programmable devices, including for example a desktop computer or laptop computer hard-drive, field-programmable gate arrays (FPGAs), application-specific integrated circuits (ASICs), application-specific standard products (ASSPs), system-on-a-chip systems (SOCs), programmable logic devices (PLDs), etc. or the like or as part of a Computing Device, and any combination thereof operable to execute the instructions associated with implementing the method of the subject matter described herein.

Computing device as referenced herein may include: a mobile telephone; a computer such as a desktop or laptop type; a Personal Digital Assistant (PDA) or mobile phone; a notebook, tablet or other mobile computing device; or the like and any combination thereof.

Computer readable storage medium or computer program product as referenced herein is tangible (and alternatively as non-transitory, defined above) and may include volatile and non-volatile, removable and non-removable media for storage of electronic-formatted information such as computer readable program instructions or modules of instructions, data, etc. that may be stand-alone or as part of a computing device. Examples of computer readable storage medium or computer program products may include, but are not limited to, RAM, ROM, EEPROM, Flash memory, CD-ROM, DVD-ROM or other optical storage, magnetic cassettes, magnetic tape, magnetic disk storage or other magnetic storage devices, or any other medium which can be used to store the desired electronic format of information and which can be accessed by the processor or at least a portion of the computing device.

The terms module and component as referenced herein generally represent program code or instructions that causes specified tasks when executed on a processor. The program code can be stored in one or more computer readable mediums.

Network as referenced herein may include, but is not limited to, a wide area network (WAN); a local area network (LAN); the Internet; wired or wireless (e.g., optical, Bluetooth, radio frequency (RF)) network; a cloud-based computing infrastructure of computers, routers, servers, gateways, etc.; or any combination thereof associated therewith that allows the system or portion thereof to communicate with one or more computing devices.

The term user and/or the plural form of this term is used to generally refer to those persons capable of accessing, using, or benefiting from the present disclosure.

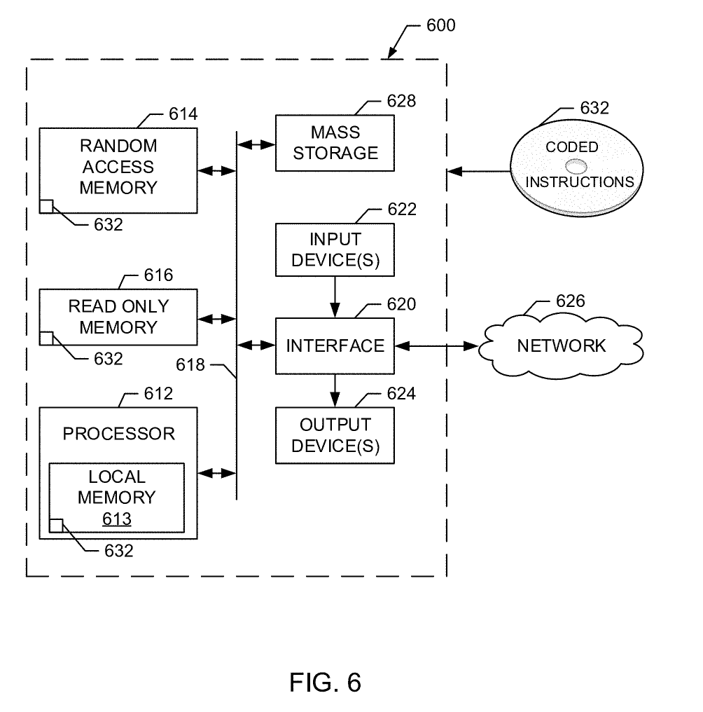

FIG. 6 is a block diagram of an example processor platform 600 capable of executing the instructions of FIG. 4 to implement the example payer provider connect engine of FIG. 3. The processor platform 800 can be, for example, a server, a personal computer, a mobile device (e.g., a cell phone, a smart phone, a tablet such as an IPAD™), a personal digital assistant (PDA), an Internet appliance, or any other type of computing device.

The processor platform 600 of the illustrated example includes a processor 612. Processor 612 of the illustrated example is hardware. For example, processor 612 can be implemented by one or more integrated circuits, logic circuits, microprocessors or controllers from any desired family or manufacturer.

Processor 612 of the illustrated example includes a local memory 613 (e.g., a cache). Processor 612 of the illustrated example is in communication with a main memory including a volatile memory 614 and a non-volatile memory 616 via a bus 818. Volatile memory 614 can be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 616 can be implemented by flash memory and/or any other desired type of memory device. Access to main memory 614, 616 is controlled by a memory controller.

Processor platform 600 of the illustrated example also includes an interface circuit 620. Interface circuit 620 can be implemented by any type of interface standard, such as an Ethernet interface, a universal serial bus (USB), and/or a PCI express interface.

In the illustrated example, one or more input devices 622 are connected to the interface circuit 620. Input device(s) 622 permit(s) a user to enter data and commands into processor 612. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 624 are also connected to interface circuit 620 of the illustrated example. Output devices 624 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). Interface circuit 620 of the illustrated example, thus, typically includes a graphics driver card, a graphics driver chip or a graphics driver processor.

Interface circuit 620 of the illustrated example also includes a communication device such as a transmitter, a receiver, a transceiver, a modem and/or network interface card to facilitate exchange of data with external machines (e.g., computing devices of any kind) via a network 626 (e.g., an Ethernet connection, a digital subscriber line (DSL), a telephone line, coaxial cable, a cellular telephone system, etc.).

Processor platform 600 of the illustrated example also includes one or more mass storage devices 628 for storing software and/or data. Examples of such mass storage devices 628 include floppy disk drives, hard drive disks, compact disk drives, Blu-ray disk drives, RAID systems, and digital versatile disk (DVD) drives.

Coded instructions 632 of FIG. 4 can be stored in mass storage device 628, in volatile memory 614, in the non-volatile memory 616, and/or on a removable tangible computer readable storage medium such as a CD or DVD.

### VI. Conclusion

Thus, certain examples provide an optimal contrast product concentration and volume for one or more patients to get the best image quality with the minimum quantity of contrast product in a given computerized tomography (CT) exam.

Certain examples facilitate providing for a patient-specific contrast protocol in order to achieve a desirable and uniform (intra- and inter-patient) organ-specific contrast enhancement for a given patient, clinical application, contrast media, CT scanner and protocol. The system will help in reducing the high variability of Hounsfield Units (HU), which represent the attenuation of x-rays, for the same clinical indication and therefore in getting a more homogeneous image quality (IQ) across and within patients for a consistent interpretability of contrast images. Currently, HU threshold per clinical indication are difficult to establish because of the large variability due to non-standard protocols. Traditionally, all patients receive a fixed iodine dose regardless of their habitus (physical state) or the specific scan protocol used, e.g., 80 kVp, 100 kVP, etc.). Image quality, in particular, the HU enhancement, the iodine dose should be modified to both patient habitus and kVp; however, iodine is known to have high toxicity and can adversely affect renal function.

This written description uses examples to disclose the subject matter, and to enable one skilled in the art to make and use the invention. The patentable scope of the subject matter is defined by the following claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system to allow for a patient-specific contrast injection protocol to achieve contrast enhancement for a given patient, comprising:
a memory that stores computer executable components;
a processor that executes computer executable components;
a contrast injection protocol component that analyzes medical information from one or more medical systems;
wherein the medical information comprises a combination of two or more parameters of:
clinical indication, anatomical region, target organ, patient morphological information, patient physiological information, contrast injection protocol, Computerized Tomography (CT) scanner type, CT acquisition parameters, CT exposure protocol, and injector type;
creating a regression model of an injection protocol using the two or more medical information factors; and
generating a patient-specific contrast injection protocol using the model.

2. The system of claim 1, wherein the model further comprises:
determining effect of contrast concentration and tube potential on Hounsfield Units (HU) enhancement by calculating a correlation between Hounsfield Units (HU) and body habitus for one or more concentration types.

3. The system of claim 2, wherein the body habitus is normalized to total iodine dose using one or more of: total body weight, height, gender, body mass index, body service area, lean body mass, fat-free mass.

4. The system of claim 1, wherein the optimal contrast injection protocol component further comprises:
receiving image and scanner information from the one or more imaging systems.

5. The system of claim 1, wherein the optimal contrast injection protocol component further comprises:
receiving patient-related information from the one or more healthcare systems.

6. The system of claim 1, wherein the patient-specific contrast injection protocol is provided to one or more scanner systems.

7. A method, comprising:
a contrast injection protocol component that analyzes medical information from one or more medical systems;
wherein the medical information comprises a combination of two or more parameters of:
clinical indication, anatomical region, target organ, patient morphological information, patient physiological information, contrast injection protocol, Computerized Tomography (CT) scanner type, CT acquisition parameters, CT exposure protocol, and injector type;
creating a regression model of an injection protocol using the two or more medical information factors; and
generating a patient-specific contrast injection protocol using the model.

8. The method of claim 7, wherein the model further comprises:
determining effect of contrast concentration and tube potential on Hounsfield Units (HU) enhancement by calculating a correlation between Hounsfield Units (HU) and body habitus for one or more concentration types.

9. The method of claim 8, wherein the body habitus is normalized to total iodine dose using one or more of:
total body weight, height, gender, body mass index, body service area, lean body mass, fat-free mass.

10. The method of claim 7, wherein the optimal contrast injection protocol component further comprises:
receiving image and scanner information from the one or more imaging systems.

11. The method of claim 7, wherein the optimal contrast injection protocol component further comprises:
receiving patient-related information from the one or more healthcare systems.

12. The method of claim 1, wherein the patient-specific contrast injection protocol is provided to one or more scanner systems.

13. A computer readable storage device comprising instructions that, in response to execution, cause a system comprising a processor to perform operations, comprising:
a contrast injection protocol component that analyzes medical information from one or more medical systems;
wherein the medical information comprises a combination of two or more parameters of:
clinical indication, anatomical region, target organ, patient morphological information, patient physiological information, contrast injection protocol, Computerized Tomography (CT) scanner type, CT acquisition parameters, CT exposure protocol, and injector type;
creating a regression model of an injection protocol using the two or more medical information factors; and
generating a patient-specific contrast injection protocol using the model.

14. The computer readable storage device of claim 13, wherein the model further comprises:
determining effect of contrast concentration and tube potential on Hounsfield Units (HU) enhancement by calculating a correlation between Hounsfield Units (HU) and body habitus for one or more concentration types.

15. The computer readable storage device of claim 14, wherein the body habitus is normalized to total iodine dose using one or more of:
total body weight, height, gender, body mass index, body service area, lean body mass, fat-free mass.

16. The computer readable storage device of claim 13, wherein the optimal contrast injection protocol component further comprises:
receiving image and scanner information from the one or more imaging systems.

17. The computer readable storage device of claim 13, wherein the optimal contrast injection protocol component further comprises:
receiving patient-related information from the one or more healthcare systems.

18. The computer readable storage device of claim 13, wherein the patient-specific contrast injection protocol is provided to one or more scanner systems.
